(19) United States
(12) Patent Application Publication
(10) Pub. No.: US 2008/0076422 A1
(43) Pub. Date: Mar. 27, 2008

(54) System and method for providing continuous media messaging during a handoff procedure in an IP-based mobile communication network

(76) Inventor: Jeou-Kai Lin, Campbell, CA (US)

Correspondence Address: FORTUNE LAW GROUP LLP, 100 CENTURY CENTER COURT, SUITE 315, SAN JOSE, CA, 95112, US

(21) Appl. No.: 11/518,562

(22) Filed: Sep. 9, 2006

(51) Int. Cl. H04Q 7/20

(52) U.S. Cl. 455/436

(57) ABSTRACT

A system and method for providing continuous media messaging during a handoff procedure in an IP-based mobile communication network is disclosed. The system for providing continuous media messaging during a handoff procedure in an IP-based mobile communication network includes an RTP proxy coupled between clients in a session, the RTP proxy operable to (a) detect the handoff procedure and (b) notify a media server with updated client information. The method includes the steps of (a) providing an RTP proxy coupled between clients in a session, (b) detecting a handoff procedure, and (c) notifying a media server with updated client information.

### BACKGROUND OF THE INVENTION

The present invention generally relates to mobile communications and more particularly to a system and method for providing media messaging in an IP-based mobile communication system.

In wireless communication systems, whether IP based (WiFi and WiMAX), or cellular based, mobility and continuity of service are ensured by handover or handoff procedures. A handoff procedure transfer's control of a mobile device from a first access point or base station to a second access point or base station when the mobile device moves out of range of the first access point or base station. The handoff procedure may determine not only which of a plurality of second access points or base stations to transfer control to, but also the timing of such transfer.

Media servers conventionally manage registration, invitation, acknowledgement, goodbye, and de-registration messages during the duration of a communication session. After the media server connects two clients in a communication session, it usually off-hooks the peer-to-peer communication and awaits further instructions from one of the clients to either end the communication or respond to another request.

During a handoff procedure, one client may move from one subnet or domain to another. In this case, media messages cannot be correctly delivered to the correct media client for real time peer to peer communications unless each client is using an ad hoc communication mode without a media server. However, given that most real time applications such as voice over IP (VoIP), video conferencing and instant messaging utilize a Session Initialization Protocol (SIP) or H323 media server, the ability to provide media messaging during handoff procedures is critical.

While proprietary solutions exist to deal with media messaging during handoff, this solution is not extensible.

There is therefore a need in the art for a system and method for providing media messaging in an IP-based mobile communication system that overcomes the problems of the prior art. There is a further need for a system and method that provides real time updates to a media server in the event of a handoff procedure. There is also a need for a system and method that is a server side add-on requiring no client side or network infrastructure modification.

### SUMMARY OF THE INVENTION

In accordance with the invention, an RTP proxy is assigned to behave as a mobile media agent during an RTP session. The RTP proxy relays real time communication between two real time endpoints to the media server and detects handoff procedures during the RTP session.

In accordance with one aspect of the invention, a system for providing continuous media messaging during a handoff procedure in an IP-based mobile communication network includes an RTP proxy coupled between clients in a session, the RTP proxy operable to (a) detect the handoff procedure and (b) notify a media server with updated client information.

In accordance with another aspect of the invention, a method for providing continuous media messaging includes the steps of providing an RTP proxy coupled between clients in a session, detecting a handoff procedure; and notifying a media server with updated client information.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These and other features, aspects and advantages of the present invention will become better understood with reference to the following drawings, description and claims.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic representation showing a first phase of an RTP session in accordance with the invention;

FIG. 2 is a schematic representation showing a second phase of the RTP session in accordance with the invention;

FIG. 3 is a schematic representation showing a third phase of an RTP session in accordance with the invention; and

FIG. 4 is a schematic representation showing a fourth phase of an RTP session in accordance with the invention.

### DETAILED DESCRIPTION OF THE INVENTION

The present invention provides a system and method for providing media messaging in an IP-based mobile communication system. An RTP proxy is assigned to behave as a mobile media agent during an RTP session. The RTP proxy relays real time communication between two real time endpoints to the media server and detects handoff procedures during the RTP session

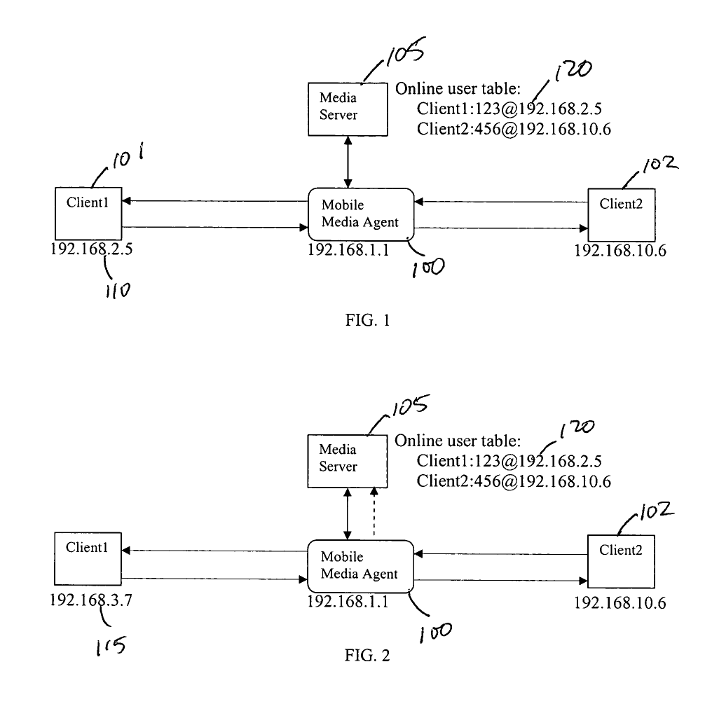

With reference to FIG. 1, an RTP session is represented between client 101 and client 102 (endpoints 101 and 102). A mobile media agent 100 acts as an intermediary between client 101 and client 102. Clients 101 and 102 communicate with each other through the mobile media agent 100. The mobile media agent 100 is coupled to a media server 105.

After a handoff procedure, client 101 may move to a subnet having a different IP address. For example, the client 101 may move from subnet 110 having the IP address 192.168.2.5 to the subnet 115 having the IP address 192.168.3.7 as shown in FIG. 2. The mobile media agent 100 detects the handoff procedure and communicates the change of IP address to the media server 105.

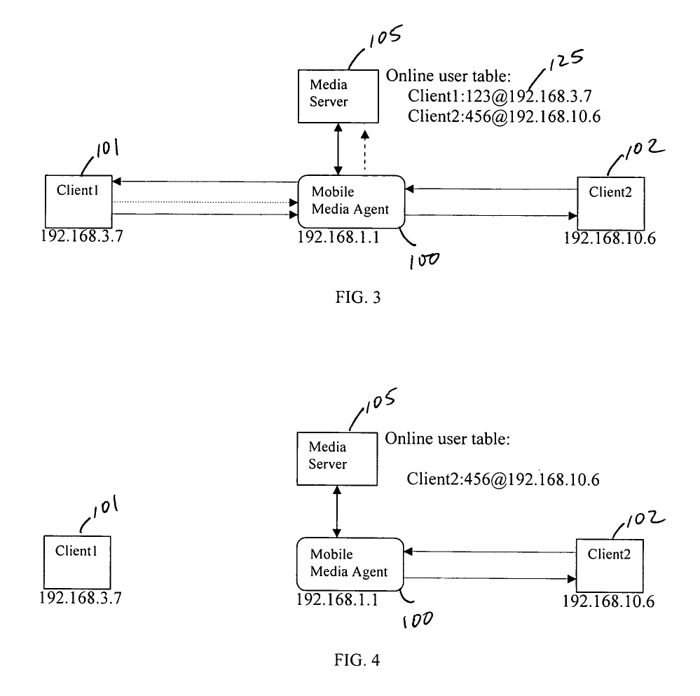

With reference to FIG. 3, the media server 105 will update a user table with the new SIP IP address 125. A subsequent message from the client 101 such as “bye” or “de-register” will then be correctly identified by the media server 105.

As shown in FIG. 4, after the media server 105 handles the message from the client 101 the user table will be updated.

The system and method for providing media messaging in an IP based mobile communication system in accordance with the invention provides a mobile media agent that detects handoff procedures in an RTP session. The media server is notified of each handoff procedure by the mobile media agent. The media server is thus enabled to correctly handle client messages.

It should be understood, of course, that the foregoing relates to preferred embodiments of the invention and that modifications may be made without departing from the spirit and scope of the invention as set forth in the following claims.

I claim:

1. A system for providing continuous media messaging during a handoff procedure in an IP-based mobile communication network comprising:
an RTP proxy coupled between clients in a session, the RTP proxy operable to (a) detect the handoff procedure and (b) notify a media server with updated client information.

2. The system of claim 1, wherein the updated client information comprises an updated client IP address.

3. A method of providing continuous media messaging during a handoff procedure in an IP-based mobile communication network comprising the steps of:
providing an RTP proxy coupled between clients in a session;
detecting a handoff procedure; and
notifying a media server with updated client information.

4. The method of claim 3, wherein the updated client information comprises an updated client IP address.
